(19) United States
(12) Patent Application Publication
(10) Pub. No.: US 2022/0404502 A1
(43) Pub. Date: Dec. 22, 2022

(54) LASER RADAR

(71) Applicant: Panasonic Intellectual Property Management Co., Ltd., Osaka (JP)

(72) Inventors: Yasuyuki KANO, Osaka (JP); Ryo FUKUDA, Osaka (JP); Akihiro ARAI, Osaka (JP)

(21) Appl. No.: 17/890,911

(22) Filed: Aug. 18, 2022

Related U.S. Application Data
(63) Continuation of application No. PCT/JP2021/003106, filed on Jan. 28, 2021.

(30) Foreign Application Priority Data
Feb. 25, 2020 (JP) 2020-029755

(51) Int. Cl. G01S 17/88; G01S 7/481

(52) U.S. Cl. CPC G01S 17/88; G01S 7/4816; G01S 7/4817

(57) ABSTRACT

A laser radar includes: a projector configured to project laser light in a direction having an acute angle with respect to a rotation axis; a light receiver configured to condense reflected light of the laser light onto a photodetector; a rotary part to rotate the projector and the light receiver to form an object detection surface having a conical shape; and a controller configured to detect entry of an object into a three-dimensional monitoring region. The object detection surface is set so as to widen toward the monitoring region. The controller sets a detection range corresponding to the monitoring region, on the object detection surface, and detects entry of the object into the monitoring region by a position of the object on the object detection surface, which is detected on the basis of emission of the laser light and reception of the reflected light, being included in the detection range.

### CROSS REFERENCE TO RELATED APPLICATION

This application is a continuation of International Application No. PCT/JP2021/003106 filed on Jan. 28, 2021, entitled “LASER RADAR”, which claims priority under 35 U.S.C. Section 119 of Japanese Patent Application No. 2020-029755 filed on Feb. 25, 2020, entitled “LASER RADAR”. The disclosures of the above applications are incorporated herein by reference.

### BACKGROUND OF THE INVENTION

### 1. Field of the Invention

The present invention relates to a laser radar for detecting an object by using laser light.

### 2. Disclosure of Related Art

A laser radar can be used for detecting entry of a person into a predetermined monitoring region. Generally, the laser radar performs scanning with laser light on a detection target region, and detects the presence/absence of an object at each scanning position on the basis of reflected light at each scanning position. In addition, the laser radar detects the distance to the object at each scanning position on the basis of the time taken from the irradiation timing of the laser light to the reception timing of the reflected light at each scanning position.

Japanese Laid-Open Patent Publication No. 2015-81921 describes a sensor which performs scanning with light while rotating a scanning unit about a rotation axis. As a specific configuration example, the scanning unit emits light in a direction perpendicular to the rotation axis, receives the light reflected by an object, and calculates the distance to the object.

In the above configuration, scanning is horizontally performed with the light around the rotation axis. Thus, for example, in the case where the operating region of an articulated robot is a monitoring region, the above sensor is installed on the lateral side of the articulated robot. Accordingly, an area around the articulated robot is scanned with the light, and the presence/absence of an object is detected. However, in the case where the sensor is installed on the lateral side of the articulated robot as described above, the light is blocked by the articulated robot in a part of the scanning range around the rotation axis. Therefore, it is not possible to properly detect approach of a person in this scanning range.

### SUMMARY OF THE INVENTION

A main aspect of the present invention is directed to a laser radar. The laser radar according to this aspect includes: a projector configured to project laser light emitted from a light source, in a direction having an acute angle with respect to a rotation axis; a light receiver configured to condense reflected light, of the laser light, by an object, onto a photodetector; a rotary part configured to rotate the projector and the light receiver about the rotation axis to form an object detection surface having a conical shape; and a controller configured to detect entry of the object into a three-dimensional monitoring region. The object detection surface is set so as to widen toward the monitoring region, and the controller sets a detection range corresponding to the monitoring region, on the object detection surface, and detects entry of the object into the monitoring region by a position of the object on the object detection surface, which is detected on the basis of emission of the laser light and reception of the reflected light, being included in the detection range.

In the laser radar according to this aspect, the object detection surface is set so as to widen toward the monitoring region, so that the laser light with which scanning is performed along the object detection surface as the rotary part rotates is less likely to be blocked by a facility or the like inside the monitoring region. Therefore, entry of an object such as a person into the monitoring region can be more reliably detected.

Moreover, the controller detects entry of an object by comparing the position of the object on the object detection surface with the detection range set so as to correspond to the monitoring region, so that entry of the object can be detected by a simple process. That is, in detecting entry of an object, the controller may merely two-dimensionally compare, on the object detection surface having a conical shape, two parameters, the angle (the rotational position of the rotary part) in the circumferential direction and the distance in a generatrix direction (distance corresponding to the time difference between the light emission and the light reception) with the detection range. Therefore, the process of detecting entry of an object into the monitoring region can be significantly simplified compared to the case of three-dimensionally comparing the coordinate position of an object with a coordinate region of the monitoring region in a three-dimensional space including the monitoring region.

### BRIEF DESCRIPTION OF THE DRAWINGS

FIG. 1 is a perspective view for illustrating assembly of a laser radar according to an embodiment;

FIG. 2 is a perspective view showing a configuration of the laser radar in a state where assembly of a portion excluding a cover according to the embodiment is completed;

FIG. 3 is a perspective view showing a configuration of the laser radar according to the embodiment in a state where the cover is attached;

FIG. 4 is a cross-sectional view showing a configuration of the laser radar according to the embodiment;

FIG. 5 is a perspective view showing a configuration of an optical system of an optical unit according to the embodiment;

FIG. 6 is a side view showing the configuration of the optical system of the optical unit according to the embodiment;

FIG. 7A is a top view of the laser radar according to the embodiment as viewed in a Z-axis negative direction;

FIG. 7B is a schematic diagram showing a projection angle of projection light of each optical unit according to the embodiment when each optical unit is positioned on an X-axis positive side of a rotation axis;

FIG. 8 is a circuit block diagram showing the configuration of the laser radar according to the embodiment;

FIG. 9A and FIG. 9B are each a perspective view schematically showing a robot according to the embodiment, a monitoring region, and a person approaching the robot;

FIG. 10A is a perspective view conceptually showing object detection surfaces and detection ranges according to the embodiment;

FIG. 10B is a side view conceptually showing a cross-section on an X-axis positive side with respect to the rotation axis, of a cross-section obtained by cutting the object detection surfaces and the detection ranges according to the embodiment along an X-Z plane passing through the rotation axis;

FIG. 11A to FIG. 11F schematically show the object detection surfaces and the detection ranges according to the embodiment;

FIG. 12A to FIG. 12F schematically show the object detection surfaces and the detection ranges according to the embodiment;

FIG. 13 is a flowchart showing an object detection process of the laser radar according to the embodiment.

FIG. 14A and FIG. 14B are each a side view schematically showing entry detection in the case where the number of sets of projectors and light receivers is one, according to a comparative example;

FIG. 15A is a perspective view conceptually showing object detection surfaces and detection ranges according to a modification;

FIG. 15B is a side view conceptually showing a cross-section on an X-axis positive side with respect to a rotation axis, of a cross-section obtained by cutting the object detection surfaces and the detection ranges according to the modification along an X-Z plane passing through the rotation axis;

FIG. 16A to FIG. 16F schematically show the object detection surfaces and the detection ranges according to the modification;

FIG. 17A to FIG. 17F schematically show the object detection surfaces and the detection ranges according to the modification;

FIG. 18 is a flowchart showing an object detection process of a laser radar according to the modification; and

FIG. 19A and FIG. 19B are each a plan view schematically showing a monitoring region and projection light according to another modification, as viewed in a Z-axis negative direction.

It should be noted that the drawings are solely for description and do not limit the scope of the present invention by any degree.

### DESCRIPTION OF PREFERRED EMBODIMENTS

Hereinafter, an embodiment of the present invention will be described with reference to the drawings. For convenience, in each drawing, X, Y, and Z axes that are orthogonal to each other are additionally shown. The Z-axis positive direction is the height direction of a laser radar 1.

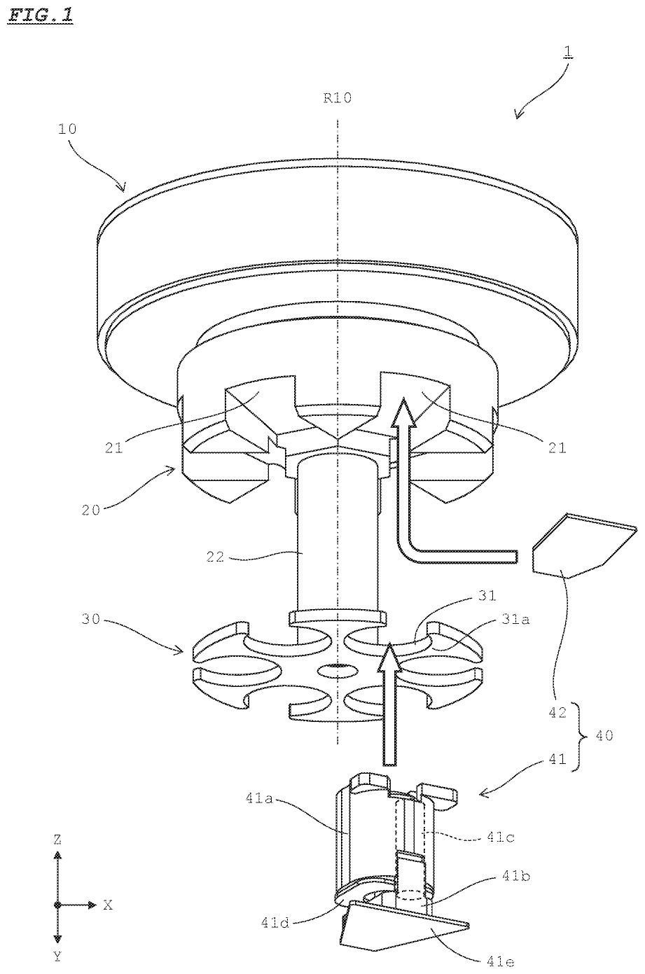

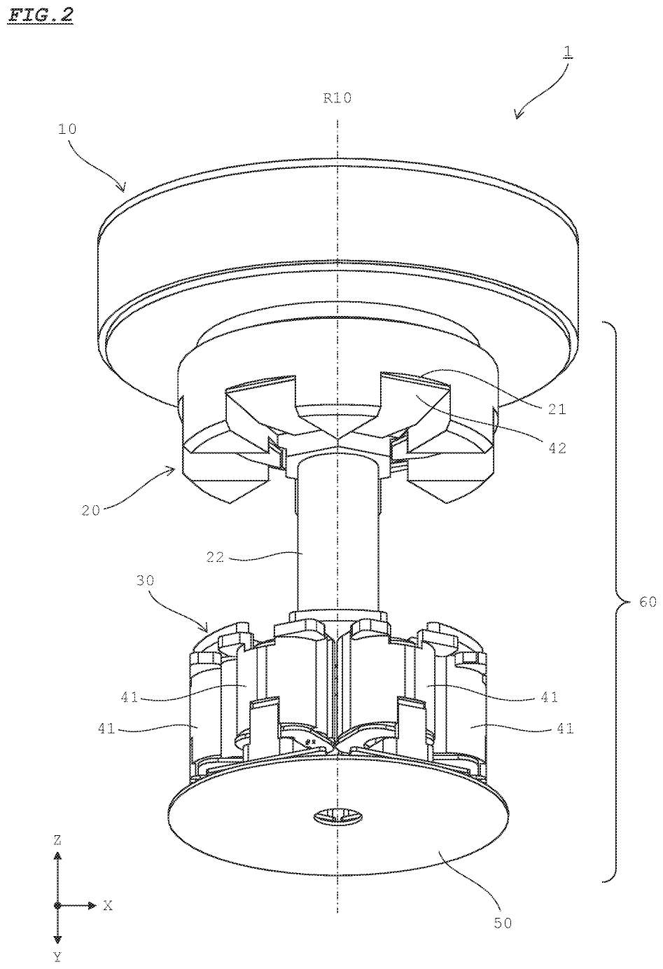

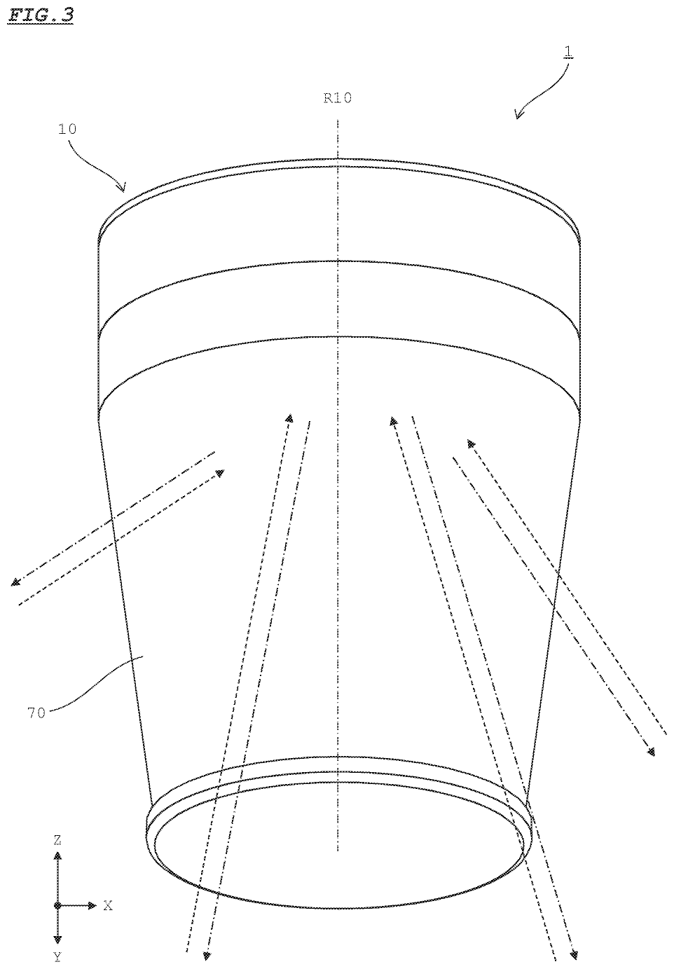

FIG. 1 is a perspective view for illustrating assembly of the laser radar 1. FIG. 2 is a perspective view showing a configuration of the laser radar 1 in a state where assembly of a portion excluding a cover 70 is completed. FIG. 3 is a perspective view showing a configuration of the laser radar 1 in a state where the cover 70 is attached.

As shown in FIG. 1, the laser radar 1 includes a fixing part 10 having a columnar shape, a base member 20 rotatably disposed on the fixing part 10, a disk member 30 installed on the lower surface of the base member 20, and optical units 40 installed on the base member 20 and the disk member 30. FIG. 1 is a view of the laser radar 1 as viewed obliquely from below. The Z-axis positive direction is the upward direction, and a Y-axis positive direction is the depth direction.

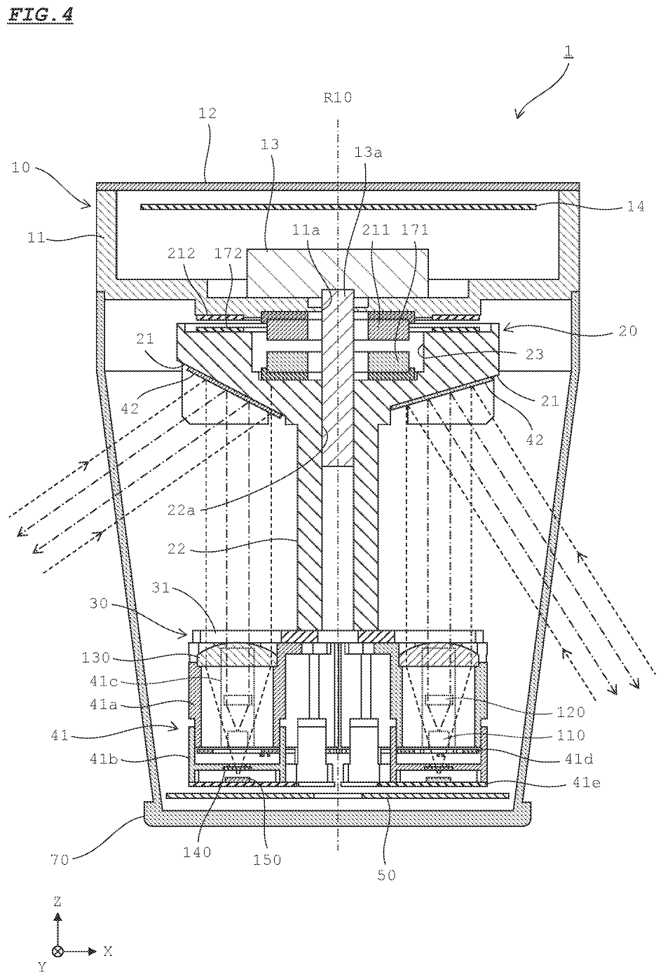

The base member 20 is installed on a drive shaft 13a of a motor 13 (see FIG. 4) provided in the fixing part 10. The base member 20 rotates about a rotation axis R10 parallel to the Z-axis direction by drive of the drive shaft 13a. The base member 20 has a columnar outer shape. In the base member 20, six installation surfaces 21 are formed at equal intervals (60° intervals) along the circumferential direction about the rotation axis R10. Each installation surface 21 is inclined with respect to a plane (X-Y plane) perpendicular to the rotation axis R10. The lateral side (direction away from the rotation axis R10) of the installation surface 21 and the lower side (Z-axis negative direction) of the installation surface 21 are open. The inclination angles of the six installation surfaces 21 are different from each other. In addition, a shaft portion 22 is formed at the center of the lower side of the base member 20 so as to extend in the Z-axis negative direction.

The disk member 30 is a plate member having an outer shape that is a disk shape. In the disk member 30, six circular holes 31 are formed at equal intervals (60° intervals) along the circumferential direction about the rotation axis R10. Each hole 31 penetrates the disk member 30 in the direction of the rotation axis R10 (Z-axis direction). The disk member 30 is installed on the lower surface of the shaft portion 22 of the base member 20 such that the six holes 31 are respectively positioned below the six installation surfaces 21 of the base member 20.

Each optical unit 40 includes a structure 41 and a mirror 42. The structure 41 includes two holding members 41a and 41b, a light blocking member 41c, and two substrates 41d and 41e. The holding members 41a and 41b and the light blocking member 41c hold each component of an optical system included in the structure 41. The holding member 41b is installed on a lower portion of the holding member 41a. The light blocking member 41c is held by the holding member 41a. The substrates 41d and 41e are installed on the lower surfaces of the holding members 41a and 41b, respectively. The structure 41 emits laser light in the upward direction (Z-axis positive direction), and receives laser light from the upper side. The optical system included in the structure 41 will be described later with reference to FIGS. 4 to 6.

As shown in FIG. 1, each structure 41 is installed on a surface 31a around the hole 31 from the lower side of the hole 31 with respect to the structure consisting of the fixing part 10, the base member 20, and the disk member 30. Accordingly, six optical units 40 are arranged at equal intervals (60° intervals) along the circumferential direction about the rotation axis R10. In addition, each mirror 42 is installed on the installation surface 21. The mirror 42 is a plate member in which a surface installed on the installation surface 21 and a reflecting surface 42a on the side opposite to the installation surface 21 are parallel to each other. As described above, an installation region for installing one optical unit 40 is formed by the surface 31a for installing the structure 41 and the installation surface 21 which is located above the surface 31a and which is for installing the mirror 42. In the present embodiment, six installation regions are provided, and the optical unit 40 is installed on each installation region.

Subsequently, a substrate 50 is installed on the lower surface side of the six structures 41 as shown in FIG. 2. Accordingly, the assembly of a rotary part 60 including the base member 20, the disk member 30, the six optical units 40, and the substrate 50 is completed. The rotary part 60 rotates about the rotation axis R10 by driving the drive shaft 13a (see FIG. 4) of the motor 13 of the fixing part 10.

Then, in the state shown in FIG. 2, the cover 70 having a cylindrical shape, which covers the lower side and the lateral side of the rotary part 60, is installed on an outer peripheral portion of the fixing part 10 as shown in FIG. 3. An opening is formed at the upper end of the cover 70, and the inside of the cover 70 is hollow. The rotary part 60 which rotates inside the cover 70 is protected by installing the cover 70. In addition, the cover 70 is made of a material that allows laser light to pass therethrough. The cover 70 is made of, for example, polycarbonate. Accordingly, the assembly of the laser radar 1 is completed.

In detecting an object by the laser radar 1, laser light (projection light) is emitted from a laser light source 110 (see FIG. 4) of each structure 41 in the upward direction (Z-axis positive direction). The projection light is reflected by the mirror 42 in a direction away from the rotation axis R10. The projection light reflected by the mirror 42 passes through the cover 70 and is emitted to the outside of the laser radar 1. As shown by alternate long and short dash lines in FIG. 3, the projection light is emitted from the cover 70 radially with respect to the rotation axis R10, and projected toward a scanning region located around the laser radar 1. Then, the projection light (reflected light) reflected by an object existing in the scanning region is incident on the cover 70 as shown by broken lines in FIG. 3, and taken into the laser radar 1. The reflected light is reflected in the downward direction (Z-axis negative direction) by the mirror 42 and received by a photodetector 150 (see FIG. 4) of the structure 41.

The rotary part 60 shown in FIG. 2 rotates around the rotation axis R10. With the rotation of the rotary part 60, the optical axis of each projection light travelling from the laser radar 1 toward the scanning region rotates about the rotation axis R10. Along with this, the scanning region (scanning position of the projection light) also rotates.

The laser radar 1 determines whether or not an object exists in the scanning region, on the basis of whether or not the reflected light is received. In addition, the laser radar 1 measures the distance to the object existing in the scanning region, on the basis of the time difference (time of flight) between the timing when the projection light is projected to the scanning region and the timing when the reflected light is received from the scanning region. When the rotary part 60 rotates about the rotation axis R10, the laser radar 1 can detect objects that exist over substantially the entire circumference of 360 degrees around the laser radar 1.

FIG. 4 is a cross-sectional view showing a configuration of the laser radar 1.

FIG. 4 shows a cross-sectional view of the laser radar 1 shown in FIG. 3 taken at the center position in the Y-axis direction along a plane parallel to the X-Z plane. In FIG. 4, a flux of the laser light (projection light) emitted from the laser light source 110 of each optical unit 40 and travelling toward the scanning region is shown by an alternate long and short dash line, and a flux of the laser light (reflected light) reflected from the scanning region is shown by a broken line. In addition, in FIG. 4, for convenience, the positions of each laser light source 110, each collimator lens 120, and each light blocking member 41c are shown by dotted lines.

As shown in FIG. 4, the fixing part 10 includes a columnar support base 11, a top plate 12, the motor 13, a substrate 14, a non-contact power feeding part 211, and a non-contact communication part 212.

The support base 11 is made of, for example, a resin. The upper surface of the support base 11 is closed by the top plate 12 having a circular dish shape. A hole 11a is formed at the center of the lower surface of the support base 11 so as to penetrate the lower surface of the support base 11 in the Z-axis direction. The lower surface of the motor 13 is installed around the hole 11a on the inner surface of the support base 11. The motor 13 includes the drive shaft 13a extending in the downward direction, and rotates the drive shaft 13a about the rotation axis R10.

The non-contact power feeding part 211 is installed around the hole 11a on the outer surface of the support base 11 along the circumferential direction about the rotation axis R10. The non-contact power feeding part 211 is composed of a coil capable of supplying power to and being supplied with power from a non-contact power feeding part 171 described later. In addition, the non-contact communication part 212 is installed around the non-contact power feeding part 211 on the outer surface of the support base 11 along the circumferential direction about the rotation axis R10. The non-contact communication part 212 is composed of a substrate on which electrodes and the like capable of wireless communication with a non-contact communication part 172 described later are arranged.

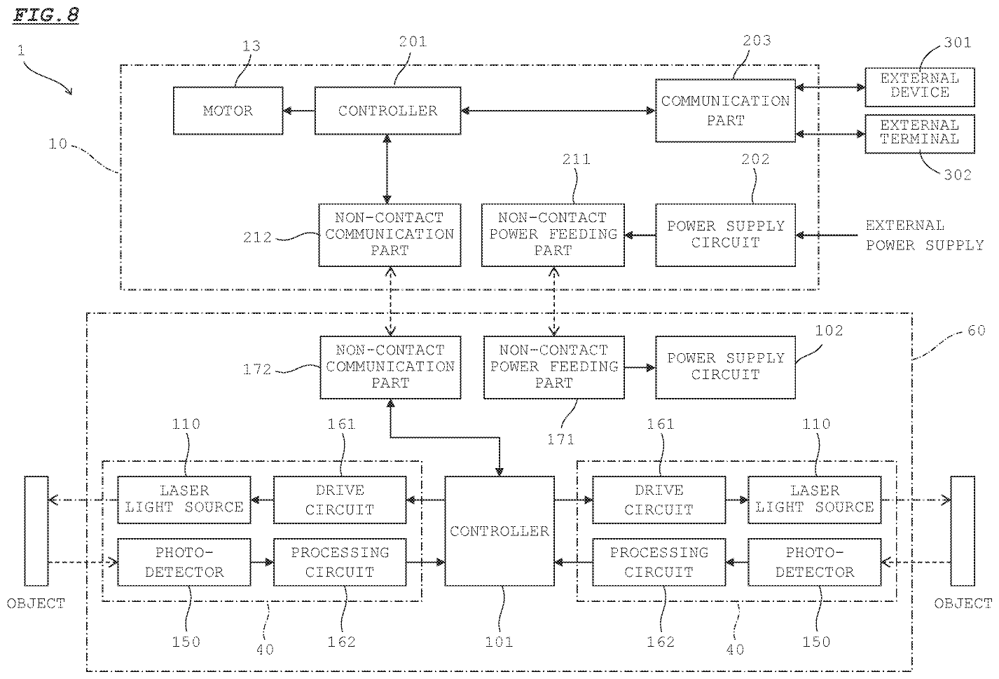

A controller 201, a power supply circuit 202, and a communication part 203 (see FIG. 8), which will be described later, are installed on the substrate 14. The motor 13, the non-contact power feeding part 211, and the non-contact communication part 212 are electrically connected to the substrate 14.

The shaft portion 22 is formed at the center of the lower surface of the base member 20 so as to extend in the Z-axis negative direction, and a hole 22a is formed in the shaft portion 22 so as to penetrate the shaft portion 22 along the rotation axis R10. An opening 23 is formed at the center of the upper surface of the base member 20 and connected to the hole 22a of the shaft portion 22. By installing the drive shaft 13a of the motor 13 in the hole 22a via the opening 23, the base member 20 is supported on the fixing part 10 so as to be rotatable about the rotation axis R10. The non-contact power feeding part 171 is installed on an outer peripheral region of the bottom surface of the opening 23 along the circumferential direction about the rotation axis R10. The non-contact power feeding part 171 is composed of a coil capable of being supplied with power from the non-contact power feeding part 211 of the fixing part 10. In addition, the non-contact communication part 172 is installed around the opening 23 in the upper surface of the base member 20 along the circumferential direction about the rotation axis R10. The non-contact communication part 172 is composed of a substrate on which electrodes and the like capable of wireless communication with the non-contact communication part 212 of the fixing part 10 are arranged.

As described with reference to FIG. 1, the six installation surfaces 21 are formed in the base member 20 along the circumferential direction about the rotation axis R10, and the mirror 42 is installed on each of the six installation surfaces 21. The reflection points at which the respective mirrors 42 reflect the projection lights emitted from the structures 41 in the Z-axis positive direction are arranged along a circumference centered on the rotation axis R10. The disk member 30 is installed on the lower surface of the shaft portion 22. Each structure 41 is installed on the lower surface of the disk member 30 such that the hole 31 of the disk member 30 and the opening formed in the upper surface of the holding member 41a coincide with each other.

Each structure 41 includes the laser light source 110, the collimator lens 120, a condensing lens 130, a filter 140, and the photodetector 150 as components of the optical system.

Holes are formed in the holding members 41a and 41b and the light blocking member 41c so as to penetrate the holding members 41a and 41b and the light blocking member 41c in the Z-axis direction. The light blocking member 41c is a tubular member. The laser light source 110 is installed on the substrate 41d installed on the lower surface of the holding member 41a, and the emission end face of the laser light source 110 is positioned inside the hole formed in the light blocking member 41c. The collimator lens 120 is positioned inside the hole formed in the light blocking member 41c, and is installed on the side wall of this hole. The condensing lens 130 is held in the hole formed in the holding member 41a. The filter 140 is held in the hole formed in the holding member 41b. The photodetector 150 is installed on the substrate 41e installed on the lower surface of the holding member 41b.

A controller 101 and a power supply circuit 102 (see FIG. 8), which will be described later, are installed on the substrate 50. The six substrates 41d, the six substrates 41e, the non-contact power feeding part 171, and the non-contact communication part 172 are electrically connected to the substrate 50.

Each laser light source 110 emits laser light (projection light) having a predetermined wavelength. The emission optical axis of the laser light source 110 is parallel to the Z-axis. The collimator lens 120 converges the projection light emitted from the laser light source 110 and converts the projection light to substantially parallel light. The projection light converted to parallel light by the collimator lens 120 is incident on the mirror 42. The projection light incident on the mirror 42 is reflected by the mirror 42 in a direction away from the rotation axis R10. Then, the projection light passes through the cover 70 and is projected to the scanning region.

Here, the angle, with respect to the rotation axis R10, of the traveling direction of the projection light reflected by the mirror 42 is an acute angle. Therefore, in the case where the laser radar 1 is installed at an upper portion of a space (for example, on a ceiling or the like), the projection light is projected toward the ground of the space.

If an object exists in the scanning region, the projection light projected to the scanning region is reflected by the object. The projection light (reflected light) reflected by the object passes through the cover 70 and is guided to the mirror 42. Then, the reflected light is reflected in the Z-axis positive direction by the mirror 42. The condensing lens 130 converges the reflected light reflected by the mirror 42.

The reflected light reflected by the object is incident on the filter 140. The filter 140 is configured to allow light in the wavelength band of the projection light emitted from the laser light source 110 to pass therethrough and to block light in the other wavelength bands. The reflected light having passed through the filter 140 is guided to the photodetector 150. The photodetector 150 receives the reflected light and outputs a detection signal corresponding to the amount of the received light. The photodetector 150 is, for example, an avalanche photodiode.

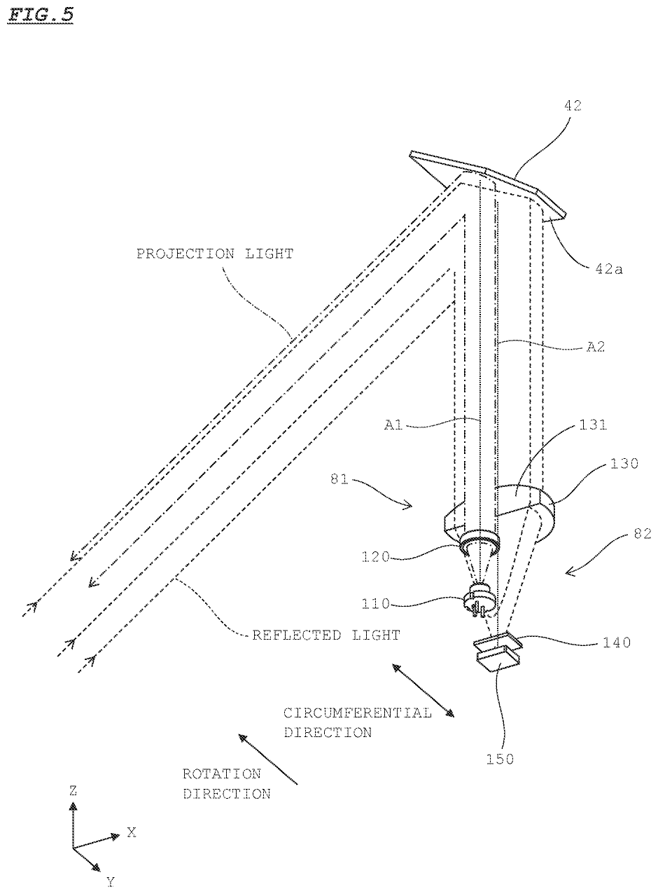

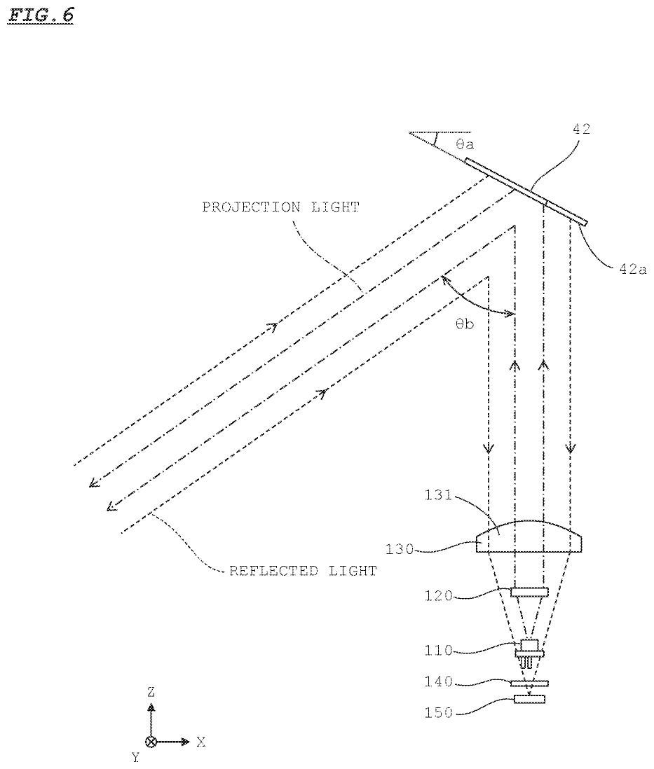

FIG. 5 is a perspective view showing a configuration of the optical system of the optical unit 40. FIG. 6 is a side view showing the configuration of the optical system of the optical unit 40.

FIGS. 5 and 6 show the optical system and the photodetector 150 of the optical unit 40 located on the X-axis negative side of the rotation axis R10 in FIG. 4. In FIGS. 5 and 6, for convenience, the optical system and the photodetector 150 of the optical unit 40 located on the X-axis negative side of the rotation axis R10 in FIG. 4 are shown, but the optical systems and the photodetectors 150 of the other optical units 40 also have the same configuration.

The laser radar 1 includes six sets of projectors 81 and light receivers 82. Each projector 81 includes the laser light source 110, the collimator lens 120, and the mirror 42, and projects the projection light emitted from the laser light source 110, in a direction having an acute angle with respect to the rotation axis R10 (see FIG. 4). Each light receiver 82 includes the mirror 42, the condensing lens 130, the filter 140, and the photodetector 150, and condenses the reflected light, of the projection light, by an object, onto the photodetector 150.

As shown in FIGS. 5 and 6, the laser light source 110 is installed at the position at the focal distance of the collimator lens 120. Accordingly, the projection light reflected by the mirror 42 is projected to the scanning region in a state of being substantially parallel light.

The reflected light from the scanning region is reflected in the Z-axis negative direction by the mirror 42 and is then incident on the condensing lens 130. An optical axis A1 of the projector 81 between the laser light source 110 and the mirror 42 and an optical axis A2 of the light receiver 82 between the mirror 42 and the photodetector 150 are each parallel to the Z-axis direction and are separated from each other by a predetermined distance in the circumferential direction about the rotation axis R10.

Here, in the present embodiment, the optical axis A1 of the projector 81 is included in the effective diameter of the condensing lens 130, and thus an opening 131 through which the optical axis A1 of the projector 81 passes is formed in the condensing lens 130. The opening 131 is formed on the outer side with respect to the center of the condensing lens 130, and is formed by cutting the condensing lens 130 along a plane parallel to the X-Z plane. By providing the opening 131 in the condensing lens 130 as described above, the optical axis A1 of the projector 81 and the optical axis A2 of the light receiver 82 can be made closer to each other, and the laser light emitted from the laser light source 110 can be incident on the mirror 42 almost without being incident on the condensing lens 130.

The light blocking member 41c shown in FIG. 4 covers the optical axis A1 of the projector 81 and also extends from the position of the laser light source 110 to the upper end of the opening 131. Accordingly, the laser light emitted from the laser light source 110 can be inhibited from being incident on the condensing lens 130.

In the present embodiment, the rotary part 60 is rotated counterclockwise about the rotation axis R10 when viewed in the Z-axis negative direction. Accordingly, each component of the projector 81 and the light receiver 82 shown in FIG. 5 is rotated in the Y-axis negative direction. As described above, in the present embodiment, the optical axis A2 of the light receiver 82 is located at a position on the rear side in the rotation direction of the rotary part 60 with respect to the optical axis A1 of the projector 81.

As shown in FIG. 6, the projection light incident on the mirror 42 is reflected in a direction corresponding to an inclination angle θa, with respect to the X-Y plane, of the reflecting surface 42a of the mirror 42. As described above, the laser radar 1 includes the six optical units 40 (see FIG. 1), and the inclination angles, with respect to the plane (X-Y plane) perpendicular to the rotation axis R10, of the installation surfaces 21 on which the mirrors 42 of the respective optical units 40 are installed are different from each other. Therefore, the inclination angles θa of the reflecting surfaces 42a of the six mirrors 42 respectively installed on the six installation surfaces (see FIG. 1) are also different from each other. Therefore, the projection lights reflected by the respective mirrors 42 are projected in directions having angles θb different from each other with respect to a direction (Z-axis direction) parallel to the rotation axis R10.

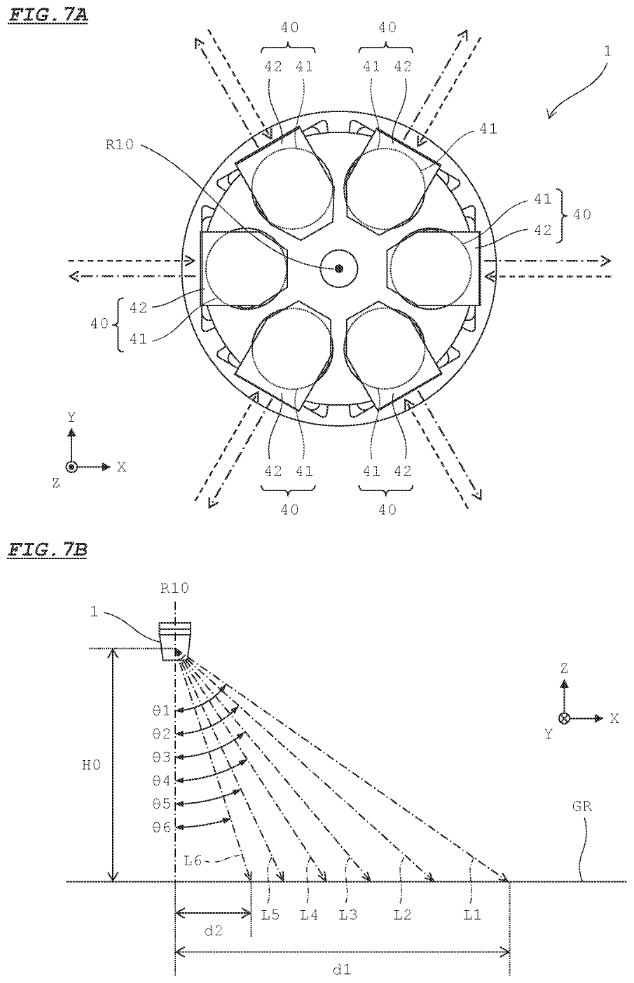

In the present embodiment, the inclination angles θa are at least set so as to be greater than 0° and less than 90°, so that the angles θb are acute angles. More specifically, each angle θb is set so as to be not less than 10° and not greater than 60°. The angle θb of each of the reflected lights reflected by the six mirrors 42 will be described later with reference to FIG. 7B.

FIG. 7A is a top view of the laser radar 1 as viewed in the Z-axis negative direction. In FIG. 7A, for convenience, the cover 70, the fixing part 10, and the base member 20 are not shown.

The six optical units 40 rotate about the rotation axis R10. At this time, the six optical units 40 project the projection light in directions away from the rotation axis R10 (radially as viewed in the Z-axis direction). While rotating at a predetermined speed, the six optical units 40 project the projection light to the scanning region, and receive the reflected light from the scanning region. Accordingly, object detection is performed over the entire circumference (360°) around the laser radar 1.

FIG. 7B is a schematic diagram showing a projection angle of the projection light of each optical unit 40 when each optical unit 40 is positioned on the X-axis positive side of the rotation axis R10. For convenience, FIG. 7B and subsequent figures show a state where the projection light is projected from a point at a predetermined height from ground GR.

As described above, the installation angles of the six mirrors 42 are different from each other. Accordingly, the projection angles of six projection lights L1 to L6 emitted from the six optical units 40, respectively, are also different from each other. In FIG. 7B, the optical axes of the six projection lights L1 to L6 are shown by alternate long and short dash lines. Projection angles θ1 to θ6 of the projection lights L1 to L6 are angles with respect to the direction (Z-axis direction) parallel to the rotation axis R10.

Here, the height from the ground GR to the laser radar 1 is denoted by H0, the distance between the position on the ground GR directly below the laser radar 1 and the position at which the projection light L1 for scanning the farthest position is denoted by d1, and the distance between the position on the ground GR directly below the laser radar 1 and the projection light L6 for scanning the nearest position is denoted by d2. In the present embodiment, the height H0 is set to 3 m, and the angles θ1 to θ6 are set to 55°, 47.5°, 40°, 32.5°, 25°, and 17.5°, respectively. Accordingly, the distance d1 is set to 4.28 m, and the distance d2 is set to 0.95 m.

FIG. 8 is a circuit block diagram showing the configuration of the laser radar 1.

The laser radar 1 includes the controller 101, the power supply circuit 102, a drive circuit 161, a processing circuit 162, the non-contact power feeding part 171, the non-contact communication part 172, the controller 201, the power supply circuit 202, the communication part 203, the non-contact power feeding part 211, and the non-contact communication part 212 as components of circuitry. The controller 101, the power supply circuit 102, the drive circuit 161, the processing circuit 162, the non-contact power feeding part 171, and the non-contact communication part 172 are disposed in the rotary part 60. The controller 201, the power supply circuit 202, the communication part 203, the non-contact power feeding part 211, and the non-contact communication part 212 are disposed in the fixing part 10.

The power supply circuit 202 is connected to an external power supply, and power is supplied from the external power supply to each component of the fixing part 10 via the power supply circuit 202. The power supplied to the non-contact power feeding part 211 is supplied to the non-contact power feeding part 171 in response to the rotation of the rotary part 60. The power supply circuit 102 is connected to the non-contact power feeding part 171, and the power is supplied from the non-contact power feeding part 171 to each component of the rotary part 60 via the power supply circuit 102.

The controllers 101 and 201 each include an arithmetic processing circuit and an internal memory, and are each composed of, for example, an FPGA or MPU. The controller 101 controls each component of the rotary part 60 according to a predetermined program stored in the internal memory thereof, and the controller 201 controls each component of the fixing part 10 according to a predetermined program stored in the internal memory thereof. The controller 101 and the controller 201 are communicably connected to each other via the non-contact communication parts 172 and 212.

The controller 201 drives each component of the fixing part 10 and transmits a drive instruction to the controller 101 via the non-contact communication parts 212 and 172. The controller 101 drives each component of the rotary part 60 in accordance with the drive instruction from the controller 201, and transmits a detection signal to the controller 201 via the non-contact communication parts 172 and 212.

The drive circuit 161 and the processing circuit 162 are provided in each of the six optical units 40. The drive circuit 161 drives the laser light source 110 in accordance with the control from the controller 101. The processing circuit 162 performs processing such as amplification and noise removal on detection signals inputted from the photodetector 150, and outputs the resultant signals to the controller 101.

In the detection operation, while controlling the motor 13 to rotate the rotary part 60 at a predetermined rotation speed, the controller 201 controls the six drive circuits 161 to emit laser light (projection light) from each laser light source 110 at a predetermined rotation angle at a predetermined timing. Accordingly, the projection light is projected from the rotary part 60 to the scanning region, and the reflected light thereof is received by the photodetector 150 of the rotary part 60. The controller 201 determines whether or not an object exists in the scanning region, on the basis of detection signals outputted from the photodetector 150. In addition, the controller 201 measures the distance to the object existing in the scanning region, on the basis of the time difference (time of flight) between the timing when the projection light is projected and the timing when the reflected light is received from the scanning region.

The communication part 203 is a communication interface, and communicates with an external device 301 and an external terminal 302. The external device 301 is a device that controls a robot RB disposed in a monitoring region RM described later. The external terminal 302 is an information terminal device including an input part. The controller 201 is communicably connected to the external device 301 and the external terminal 302 via the communication part 203.

As described later, on the basis of a detection result of whether or not an object has entered the monitoring region RM, the controller 201 transmits information regarding the detection result to the external device 301 via the communication part 203. In addition, the external terminal 302 is disconnected from the communication part 203 when the laser radar 1 is normally used, and the external terminal 302 is made connected to the communication part 203 when the monitoring region RM is to be set. The controller 201 receives setting information of the monitoring region RM from the external terminal 302.

Next, a method for detecting an object, such as a person, which has entered the monitoring region RM, by using the laser radar 1 of the present embodiment will be described.

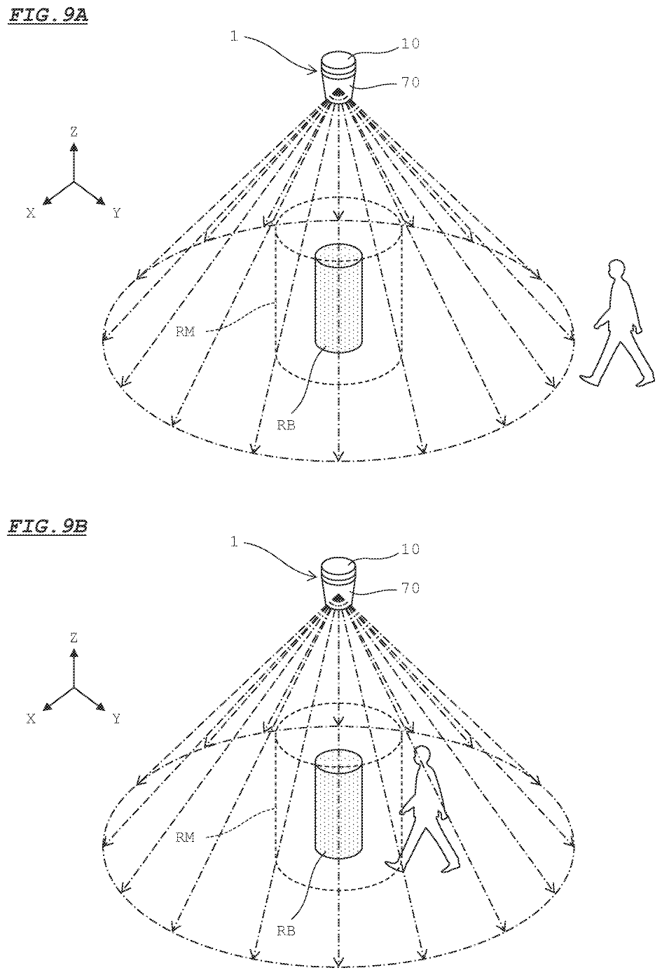

FIGS. 9A and 9B are each a perspective view schematically showing the robot RB, the monitoring region RM, and a person approaching the robot RB. In FIGS. 9A and 9B, for convenience, only the outermost projection light (projection light L1 in FIG. 7B) is shown by alternate long and short dash lines.

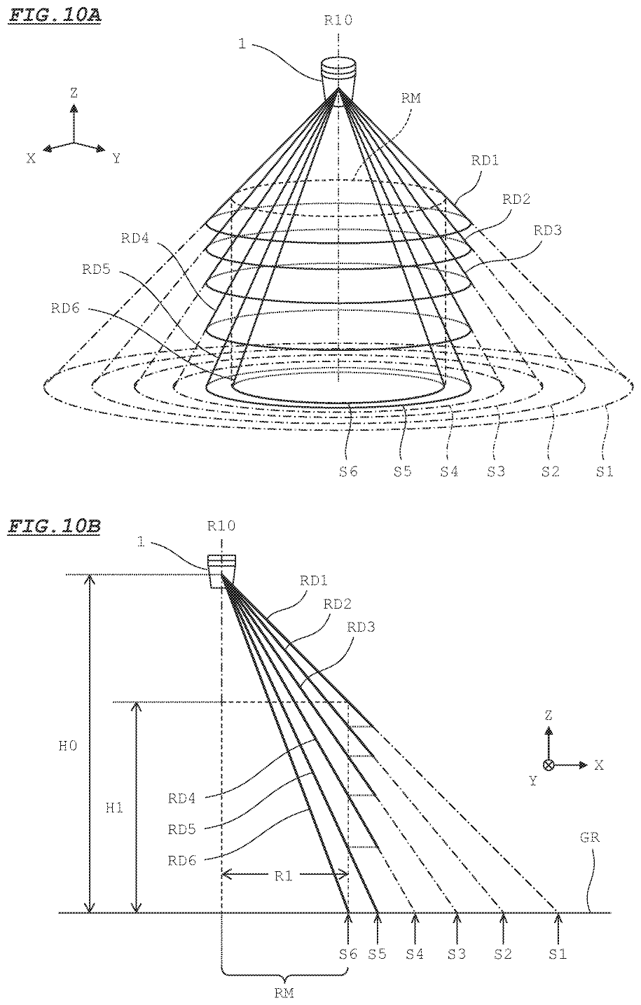

As shown in FIGS. 9A and 9B, the robot RB is installed on ground GR (see FIG. 10B) of a predetermined space area. The robot RB is, for example, an industrial robot that assembles a machine or the like by rotating arms, etc. The laser radar 1 is positioned above the robot RB by fixing the fixing part 10 to a ceiling or the like directly above the robot RB (in the Z-axis positive direction).

The monitoring region RM is a three-dimensional region that is set so as to correspond to a space slightly wider than the movable range of the robot RB (range through which the arms, etc., pass). The monitoring region RM is set, for example, to a cylindrical shape, a prismatic shape, a spherical shape, or the like according to an input from a user. Hereinafter, the case where the monitoring region RM has a cylindrical shape as shown in FIGS. 9A and 9B will be described.

The monitoring region RM shown in FIGS. 9A and 9B is a cylindrical region having a height H1 and a bottom surface with a radius R1. The setting information (height H1 and radius R1) of the monitoring region RM is stored in advance in the internal memory included in the controller 201, by setting from the user. In setting the monitoring region RM, the external terminal 302 (see FIG. 8) is made connected to the communication part 203 (see FIG. 8), and the user inputs setting information of the monitoring region RM via the external terminal 302. The controller 201 (see FIG. 8) receives the inputted setting information of the monitoring region RM and stores the setting information in the internal memory of the controller 201.

The laser radar 1 may include an input part for receiving an input of the setting information of the monitoring region RM. In addition, in the case where the monitoring region RM is set to a prismatic shape, the setting information of the monitoring region RM is, for example, the coordinates of the vertices of the prismatic shape.

The controller 201 of the laser radar 1 determines whether or not an object such as a person has entered the monitoring region RM, on the basis of the six optical units 40. When the state shown in FIG. 9A is changed to the state shown in FIG. 9B, the controller 201 determines that the person has entered the monitoring region RM.

FIG. 10A is a perspective view conceptually showing object detection surfaces S1 to S6 and detection ranges RD1 to RD6. FIG. 10B is a side view conceptually showing a cross-section located on the X-axis positive side with respect to the rotation axis R10, of a cross-section obtained by cutting the object detection surfaces S1 to S6 and the detection ranges RD1 to RD6 along the X-Z plane passing through the rotation axis R10.

When the six sets of the projectors 81 and the light receivers 82 (see FIG. 5) rotate about the rotation axis R10, the six object detection surfaces S1 to S6 having conical shapes are formed. The six object detection surfaces S1 to S6 are set so as to widen toward the monitoring region RM, and coincide with planes defined by the optical axes of the six projection lights L1 to L6 (see FIG. 7B). That is, the object detection surfaces S1 to S6 are the ranges where the optical axes of the projection lights L1 to L6 rotate about the rotation axis R10. The six object detection surfaces S1 to S6 are conical ranges starting from the position of the laser radar 1 and ending at the position of the ground GR.

Here, for convenience, it is assumed that the object detection surfaces S1 to S6 are uninterrupted and continuous over the entire circumference, but for example, when a partial angular range in the circumferential direction is set as a range for checking the light emission operation of each optical unit 40, surfaces obtained by excluding this angular range from the above conical surfaces are the object detection surfaces S1 to S6.

The controller 201 (see FIG. 8) sets the six detection ranges RD1 to RD6 on the six object detection surfaces S1 to S6, respectively, so as to correspond to the monitoring region RM set in advance. The detection ranges RD1 to RD6 set in the present embodiment are information including angles (rotational positions of the optical units 40) in the circumferential direction and distances in a generatrix direction (distances from the laser radar 1) on the object detection surfaces S1 to S6.

As shown in FIG. 10B, in the case where the monitoring region RM is a cylindrical region having a height H1 and a bottom surface with a radius R1, the detection range RD1 is set so as to have an end point at a position, on the object detection surface S1, which is advanced outward by a predetermined distance from the position at which the object detection surface S1 and the monitoring region RM intersect each other. That is, the lower end of the detection range RD1 is extended to the height position at which the object detection surface S2, which is located directly below the detection range RD1, and the side surface of the monitoring region RM intersect each other. This process is performed at each angular position in the circumferential direction about the rotation axis R10. Accordingly, when the detection range RD1 is viewed in a horizontal direction, there is no gap between the detection range RD1 and the object detection surface S2 directly below the detection range RD1. Therefore, entry of an object into the monitoring region RM in the horizontal direction can be reliably detected.

The detection ranges RD2 to RD5 are also set on the corresponding object detection surfaces S2 to S5 in the same manner as the detection range RD1. Here, the position at which the object detection surface S6 and the side surface of the monitoring region RM intersect each other is the position at which the object detection surface S6 and the ground GR intersect each other, so that the lower end of the detection range RD5 on the object detection surface S5 directly above the object detection surface S6 is extended to the ground GR. Therefore, in the example of FIG. 10B, the detection range RD5 is the same as the entire range of the object detection surface S5. Since the object detection surface S6 is located at the lowest position, the lower end of the detection range RD6 is extended to the ground GR. Therefore, the detection range RD6 is the same as the entire range of the object detection surface S6.

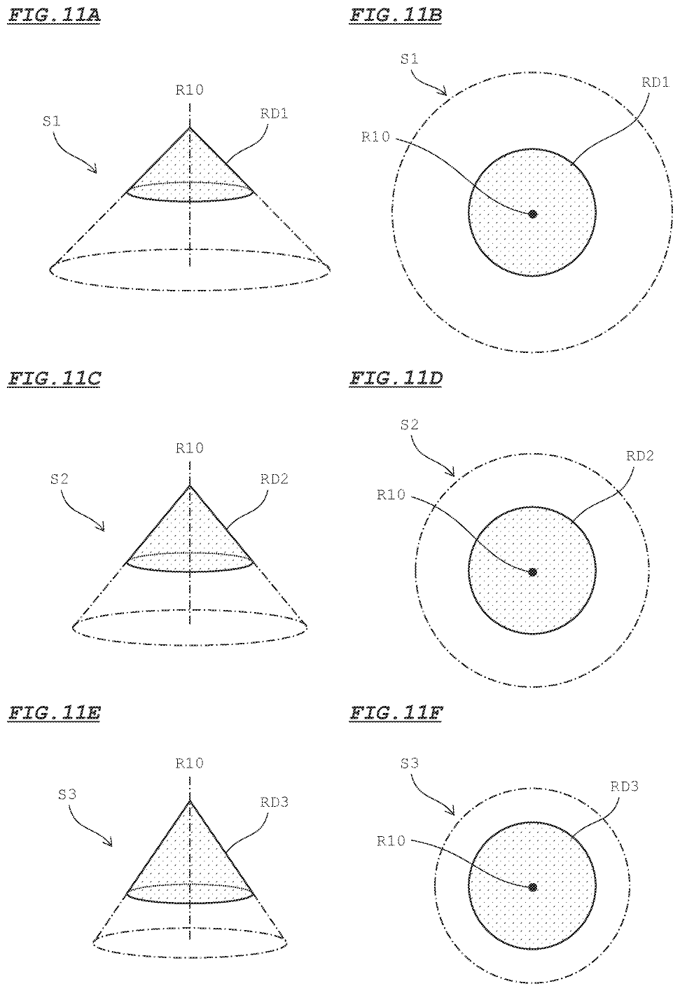

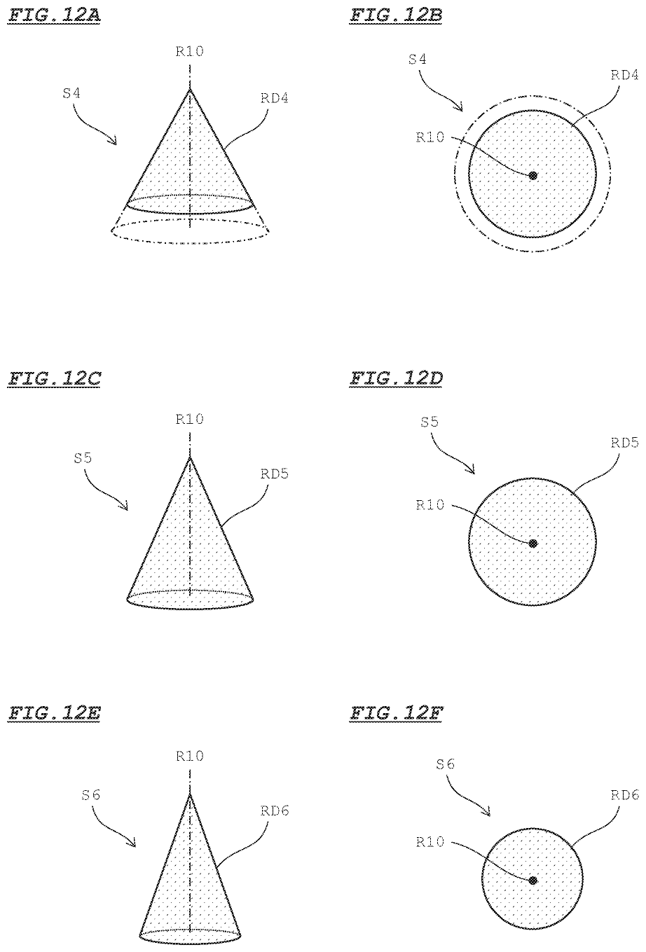

FIG. 11A to FIG. 12F schematically show the object detection surfaces and the detection ranges. FIGS. 11A and 11B schematically show the object detection surface S1 and the detection range RD1. FIGS. 11C and 11D schematically show the object detection surface S2 and the detection range RD2. FIGS. 11E and 11F schematically show the object detection surface S3 and the detection range RD3. FIGS. 12A and 12B schematically show the object detection surface S4 and the detection range RD4. FIGS. 12C and 12D schematically show the object detection surface S5 and the detection range RD5. FIGS. 12E and 12F schematically show the object detection surface S6 and the detection range RD6. FIGS. 11A, 11C, and 11E and FIGS. 12A, 12C, and 12E are perspective views, and FIGS. 11B, 11D, and 11F and FIGS. 12B, 12D, and 12F are plan views as viewed in the Z-axis direction.

As shown in FIG. 11A to FIG. 12F, the controller 201 (see FIG. 8) sets the detection ranges RD1 to RD6 corresponding to the monitoring region RM, on the object detection surfaces S1 to S6, respectively. That is, the controller 201 sets the detection ranges RD1 to RD6 on the basis of angles a in the circumferential direction and distance ranges Rw in the generatrix direction of the object detection surfaces S1 to S6. Here, the angles a in the circumferential direction correspond to the rotational positions of the optical units 40 about the rotation axis R10, and the distance ranges Rw in the generatrix direction correspond to the distance detection ranges using the optical units 40. Therefore, the controller 201 sets the rotational positions of the corresponding optical units 40 and the distance detection ranges using the optical units 40, as the detection ranges RD1 to RD6. The controller 201 stores information in which the rotational positions and the distance detection ranges are associated with each other for the respective optical units 40, as the detection ranges RD1 to RD6, in the internal memory.

The controller 201 causes projection lights to be projected from the respective optical units 40 at the angles θ1 to θ6 shown in FIG. 7B, the reflected light corresponding to each projection light is received by each optical unit 40, and the distance to an object is calculated on the basis of a time of flight. In addition, the controller 201 calculates the angle at the position of the object about the rotation axis R10 in the X-Y plane, on the basis of the angle in the circumferential direction (rotational position) of the optical unit 40 at the timing at which the reflected light is received. Then, the controller 201 determines whether or not the object exists in the detection ranges RD1 to RD6, on the basis of the calculated distance and angle. Accordingly, it is recognized whether or not the object is positioned in the monitoring region RM shown in FIGS. 10A and 10B.

The setting of the detection ranges RD1 to RD6 shown in FIG. 11A to FIG. 12F is performed by the controller 201 according to an input of the monitoring region RM to the external terminal 302 as described above.

That is, when, for setting, the external terminal 302 is made connected to the communication part 203, the controller 201 first receives an instruction to start setting of the monitoring region RM. When the user sets the monitoring region RM via the external terminal 302 accordingly, the controller 201 calculates parameters (rotational positions and distance detection ranges) that define the detection ranges RD1 to RD6, for the object detection surfaces S1 to S6, respectively, by the process described with reference to FIG. 10B. Then, the controller 201 stores the calculated parameters in the internal memory in association with the corresponding optical units 40. Thus, the process of setting the detection ranges RD1 to RD6 is completed.

In this setting process, the controller 201 calculates parameters (rotational positions and distance detection ranges) that define the detection ranges RD1 to RD6, as appropriate, according to the shape and the size of the monitoring region RM. For example, in the case where the monitoring region RM is a rectangular parallelepiped, the detection ranges RD1 to RD3 viewed from above in FIGS. 11B, 11D, and 11F and the detection ranges RD4 to RD6 viewed from above in FIGS. 12B, 12D, and 12F each have a quadrangular shape. In this case as well, the controller 201 executes the same process as described with reference to FIG. 10B, at each angular position in the circumferential direction about the rotation axis R10 to set the detection ranges RD1 to RD6 at this angular position. The same applies to the case where the monitoring region RM has another shape other than a cylindrical shape and a rectangular parallelepiped shape. As described above, the controller 201 calculates parameters (rotational positions and distance detection ranges) that define the detection ranges RD1 to RD6, according to the shape and the size of the monitoring region RM set by the user, and stores the calculated parameters in the internal memory for each optical unit 40.

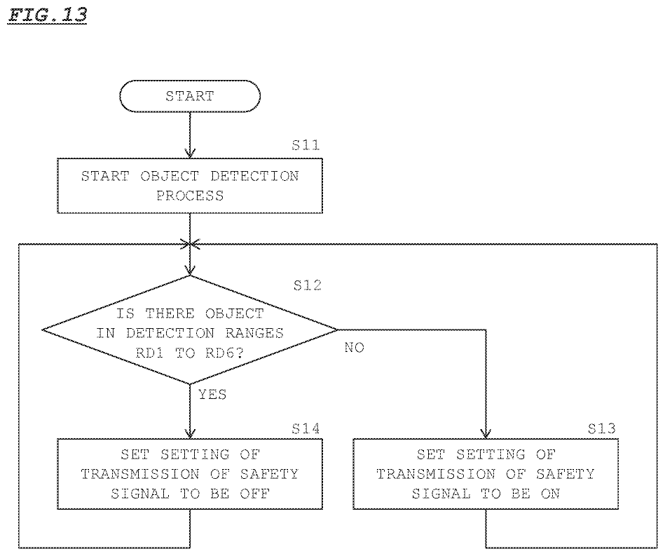

FIG. 13 is a flowchart showing an object detection process of the laser radar 1.

When the controller 201 receives an instruction to start operation via a power button or the like, the controller 201 starts the object detection process of rotating the rotary part 60, causing projection lights to be projected from the six optical units 40, and determining whether or not an object exists in the detection ranges RD1 to RD6 (S11). Specifically, the controller 201 compares the rotational positions of the six optical units 40 and the distance to an object acquired via each optical unit 40 with the information regarding the detection ranges RD1 to RD6 stored in the internal memory, and determines whether or not the object is included in the detection ranges RD1 to RD6. By starting the object detection process, it is continuously determined at predetermined time intervals whether or not the positions of the object on the object detection surfaces S1 to S6 (distances to the object and the angles in the circumferential direction of the positions of the object) are included in the corresponding detection ranges RD1 to RD6.

When the controller 201 determines that the object is not included in any of the detection ranges RD1 to RD6 (S12: NO), the controller 201 determines that the object has not entered the monitoring region RM (safe state), and sets setting of transmission of a safety signal indicating that the monitoring region RM is in the safe state (no object is detected in the monitoring region RM), to be ON (S13). Accordingly, the controller 201 transmits the safety signal to the external device 301 (see FIG. 8) via the communication part 203 (see FIG. 8). Upon receiving the safety signal from the controller 201 of the laser radar 1, the external device 301 sets the robot RB (see FIGS. 9A and 9B) to an operating state. Accordingly, when the robot RB is stopped, operation of the robot RB is resumed, and when the robot RB is operating, the operating state of the robot RB is continued.

On the other hand, when the controller 201 determines that the object is included in at least one of the detection ranges RD1 to RD6 (S12: YES), the controller 201 determines that the object has entered the monitoring region RM (unsafe state), and sets the setting of transmission of the safety signal to be OFF (S14). In this case, the safety signal is not transmitted to the external device 301. When the external device 301 no longer receives the safety signal from the controller 201 of the laser radar 1, the external device 301 stops the operation of the robot RB.

Also, when the supply of power to the laser radar 1 is stopped due to a power failure or the like, the safety signal is no longer transmitted from the laser radar 1 to the external device 301, so that the external device 301 stops the operation of the robot RB.

After executing steps S13 and S14, the controller 201 returns the process to step S12, and performs the determination in step S12 again on the basis of the result of the object detection process after a predetermined time.

<Effects of Embodiment>

According to the above embodiment, the following effects are achieved.

The rotary part 60 (see FIG. 2) rotates the projectors 81 and the light receivers 82 about the rotation axis R10 to form the object detection surfaces S1 to S6 having conical shapes (see FIGS. 10A and 10B). The controller 201 (see FIG. 8) sets the detection ranges RD1 to RD6 corresponding to the monitoring region RM, on the object detection surfaces S1 to S6, and detects entry of an object such as a person into the monitoring region RM by the positions of the object on the object detection surfaces S1 to S6, which are detected on the basis of emission of the projection light and reception of the reflected light, being included in the detection ranges RD1 to RD6.

As shown in FIG. 10A, the object detection surfaces S1 to S6 are set so as to widen toward the monitoring region RM, so that the projection lights with which scanning is performed along the object detection surfaces S1 to S6 as the rotary part 60 rotates are less likely to be blocked by the robot RB (see FIGS. 9A and 9B), etc., inside the monitoring region RM. Therefore, entry of an object such as a person into the monitoring region RM can be more reliably detected.

Moreover, the controller 201 detects entry of an object by comparing the positions of the object on the object detection surfaces S1 to S6 with the detection ranges RD1 to RD6 set so as to correspond to the monitoring region RM, so that entry of the object can be detected by a simple process. That is, in detecting entry of an object, the controller 201 may merely two-dimensionally compare, on the object detection surfaces S1 to S6 having conical shapes, two parameters, the angle (the rotational position of the rotary part 60) in the circumferential direction and the distance in the generatrix direction (distance corresponding to the time difference between the light emission and the light reception) with the detection ranges RD1 to RD6. Therefore, the process of detecting entry of an object into the monitoring region RM can be significantly simplified compared to the case of three-dimensionally comparing the coordinate position of an object with a coordinate region of the monitoring region RM in a three-dimensional space including the monitoring region RM.

A plurality of sets of the projectors 81 and the light receivers 82 are disposed, and the angles θ1 to θ6 of the projection directions of the projection lights of the respective sets with respect to the rotation axis R10 are different from each other as shown in FIG. 7B. Accordingly, the object detection surfaces S1 to S6 having different spread angles are formed by the respective sets. Since the multiple object detection surfaces S1 to S6 having different spread angles are set as described above, entry of an object into the monitoring region RM can be detected more accurately than in the case where the number of sets of the projectors 81 and the light receivers 82 is one.

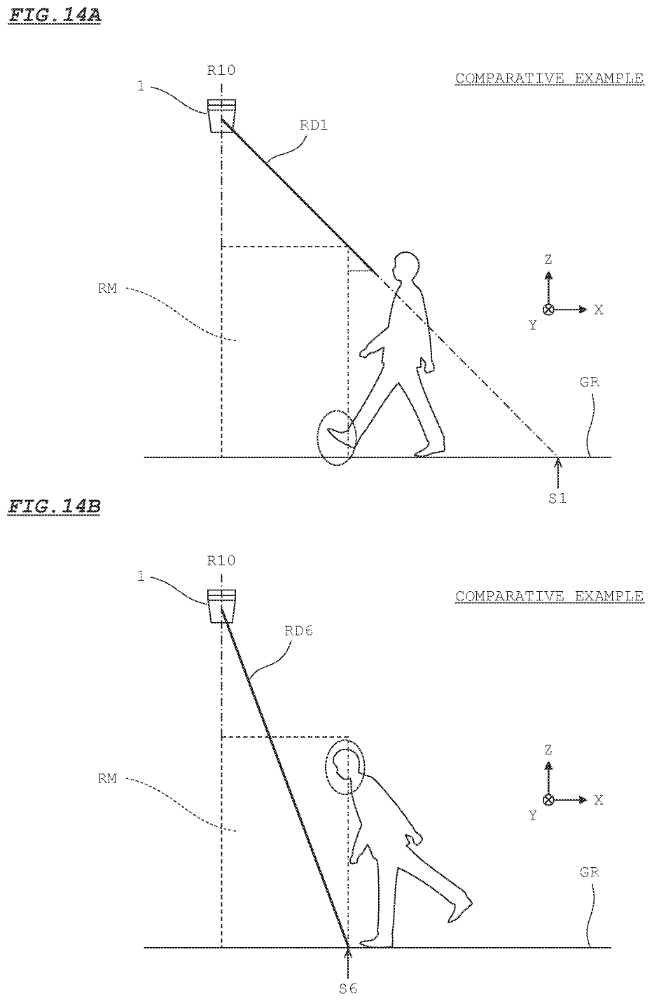

FIGS. 14A and 14B are each a side view schematically showing entry detection in the case where the number of sets of the projectors 81 and the light receivers 82 is one, according to a comparative example. In FIG. 14A, only the object detection surface S1 based on the outermost projection light is formed, and only the detection range RD1 corresponding to the monitoring region RM is set. In FIG. 14B, only the object detection surface S6 based on the innermost projection light is formed, and only the detection range RD6 corresponding to the monitoring region RM is set. In the case of FIG. 14A, it is possible to detect entry of the head of a person into the monitoring region RM, but it is impossible to detect entry of a toe part of a person into the monitoring region RM or detect entry of a short person into the monitoring region RM. In addition, in the case of FIG. 14B, it is possible to detect entry of a toe part of a person into the monitoring region RM, but when the head of a person enters the monitoring region RM earlier than a toe part of the person, it is impossible to detect entry of the person into the monitoring region RM.

On the other hand, in the above embodiment, since the plurality of sets of the projectors 81 and the light receivers 82 are disposed, the object detection surfaces S1 to S6 different from each other are formed, and the six detection ranges RD1 to RD6 corresponding to the monitoring region RM are set, as shown in FIGS. 10A and 10B. Accordingly, entry of an object into the monitoring region RM can be detected more accurately than in the comparative example of FIGS. 14A and 14B.

The controller 201 sets the detection ranges RD1 to RD6 corresponding to the monitoring region RM, on the object detection surfaces S1 to S6 formed by the respective sets of the projectors 81 and the light receivers 82. Then, the controller 201 executes the process of detecting entry of an object into the monitoring region RM, for each set of the projector 81 and the light receiver 82. As described above, entry of an object can be detected by the two-dimensional simple process on the object detection surfaces S1 to S6. Therefore, the process of detecting object entry for all the sets of the projectors 81 and the light receivers 82 can be simply performed.

Each projector 81 includes the mirror 42 which reflects the projection light, and the inclination angle θa (see FIG. 6) of the mirror 42 is made different for each set of the projector 81 and the light receiver 82, whereby the angles θ1 to θ6 (see FIG. 7B) of the projection directions of the projection lights with respect to the rotation axis R10 are different for each set. As described above, by the simple method of changing the inclination angle θa of the mirror 42, the angles θ1 to θ6 of the projection directions of the projection lights with respect to the rotation axis R10 can be made different for each set.

Since the six projectors 81 are arranged along the circumference centered on the rotation axis R10, the reflection points at which the respective mirrors 42 reflect the projection lights emitted from the structures 41 in the Z-axis positive direction are arranged along the circumference centered on the rotation axis R10. Accordingly, the edges on the inlet side (Z-axis positive side) of the object detection surfaces S1 to S6 formed by the respective projectors 81 can be caused to coincide with each other. Therefore, the six object detection surfaces S1 to S6 whose angles θ1 to θ6 (see FIG. 7B) of the projection directions of the projection lights with respect to the rotation axis R10 are different from each other, and whose edges coincide with each other can be formed. When the edges of the object detection surfaces S1 to S6 coincide with each other as described above, the distances from the rotation axis R10 to the reflection points of the respective mirrors 42 are equal to each other, so that calculation for the detection ranges RD1 to RD6 corresponding to the monitoring region RM can be smoothly performed.

The controller 201 receives setting of the monitoring region RM inputted by the user via an operation terminal or the like, and sets the detection ranges RD1 to RD6 corresponding to the received monitoring region RM, on the object detection surfaces S1 to S6. Accordingly, the user can set the monitoring region RM as desired.

On the basis of a detection result of whether or not an object such as a person has entered the monitoring region RM, the controller 201 transmits information regarding the detection result to the external device 301 via the communication part 203. Specifically, when no object has entered the monitoring region RM, the safety signal (information regarding the detection result) is transmitted, and when an object has entered the monitoring region RM, the safety signal is not transmitted. Accordingly, the external device 301 can perform appropriate control on the robot RB, such as stopping the robot RB, according to detection of entry into the monitoring region RM.

Moreover, when the supply of power to the laser radar 1 is stopped due to a power failure or the like, whether or not an object has entered the monitoring region RM is no longer detected. In this case as well, the safety signal is no longer transmitted from the laser radar 1 to the external device 301, so that the external device 301 can perform appropriate control on the robot RB such as stopping the robot RB.

Each angle θb (see FIG. 6) of the projection direction of the projection light with respect to the rotation axis R10 is set so as to be not less than 10° and not greater than 60°. In the case where the laser radar 1 is installed on a ceiling or the like above the monitoring region RM as in the above embodiment, when each angle θb of the projection direction is set in the range of not less than 10° and not greater than 60°, entry of an object into the monitoring region RM can be appropriately monitored.

<Modification>

In the above embodiment, one monitoring region RM is provided below the laser radar 1. However, in the present modification, two monitoring regions RM1 and RM2 having different sizes are provided below the laser radar 1.

In the present modification, the monitoring region RM1 for slowing down the operation of the robot RB and the monitoring region RM2 for stopping the operation of the robot RB are set. Here, the monitoring regions RM1 and RM2 are set as concentric cylindrical regions having different diameters. The monitoring region RM1 is the same as the monitoring region RM in the above embodiment. That is, in the above embodiment, the case where only one monitoring region is set is assumed, so that the monitoring region RM is set to be wide. However, in the present modification, since it is possible to set two monitoring regions, the wider monitoring region RM1 for slowing down the operation of the robot RB and the narrower monitoring region RM2 for stopping the operation of the robot RB are set.

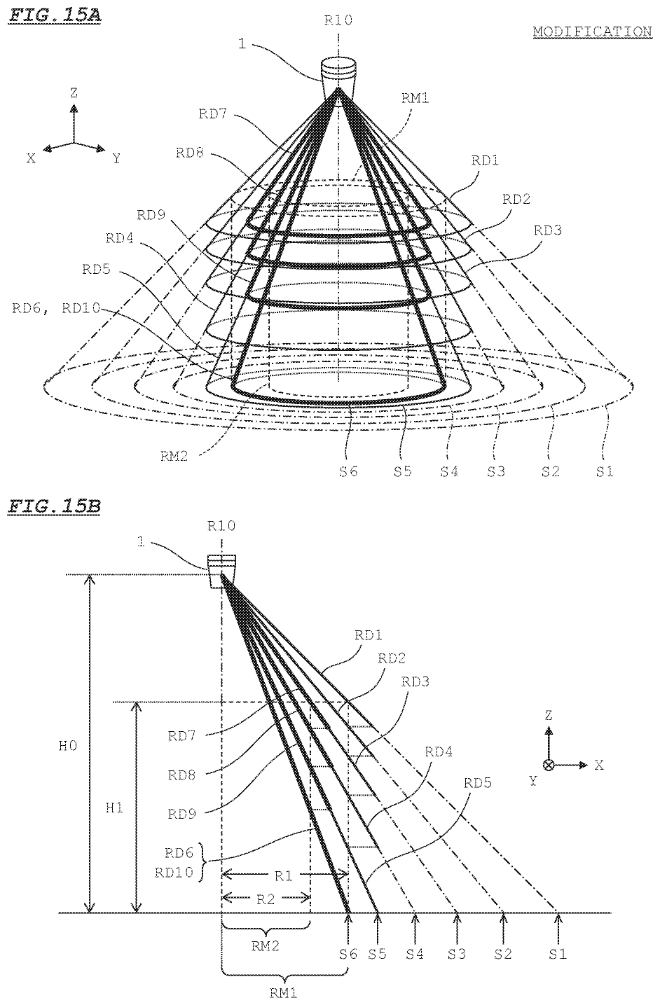

FIG. 15A is a perspective view conceptually showing object detection surfaces S1 to S6 and detection ranges RD1 to RD10 according to the present modification. FIG. 15B is a side view conceptually showing a cross-section located on the X-axis positive side with respect to the rotation axis R10, of a cross-section obtained by cutting the object detection surfaces S1 to S6 and the detection ranges RD1 to RD10 according to the present modification along the X-Z plane passing through the rotation axis R10.

The object detection surfaces S1 to S6 and the detection ranges RD1 to RD6 are the same as in the above embodiment. The monitoring region RM1 is the same as the monitoring region RM in the above embodiment, and the monitoring region RM2 is provided inside the monitoring region RM1.

Similar to the above embodiment, the controller 201 (see FIG. 8) respectively sets the six detection ranges RD1 to RD6 on the six object detection surfaces S1 to S6 which intersect the side surface of the monitoring region RM1. In addition, the controller 201 sets the four detection ranges RD7 to RD10, by the same process as in the above embodiment, on the four object detection surfaces S3 to S6 which intersect the side surface of the monitoring region RM2. That is, the lower ends of the detection ranges RD7 to RD9 are extended to the heights of the positions at which the object detection surfaces S4 to S6, which are located directly below the detection ranges RD7 to RD9, intersect the side surface of the monitoring region RM2. The detection range RD10 is the same as the entire range of the object detection surface S6.

Similar to the setting information of the monitoring region RM in the above embodiment (the monitoring region RM1 of the present modification), setting information (height H1 and radius R2) of the monitoring region RM2 is stored in the internal memory included in the controller 201. Similar to the above embodiment, the user connects the external terminal 302 (see FIG. 8) to the communication part 203 (see FIG. 8) and inputs setting information of the monitoring region RM2 together with setting information of the monitoring region RM1. The controller 201 (see FIG. 8) receives the inputted setting information of the monitoring region RM2 and stores the setting information in the internal memory of the controller 201.

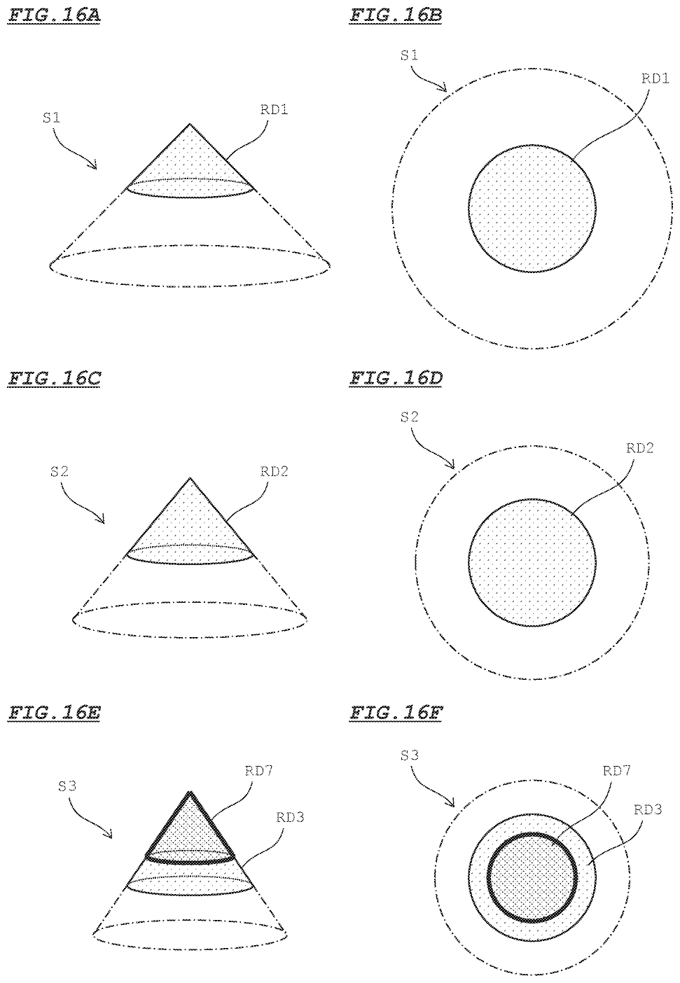

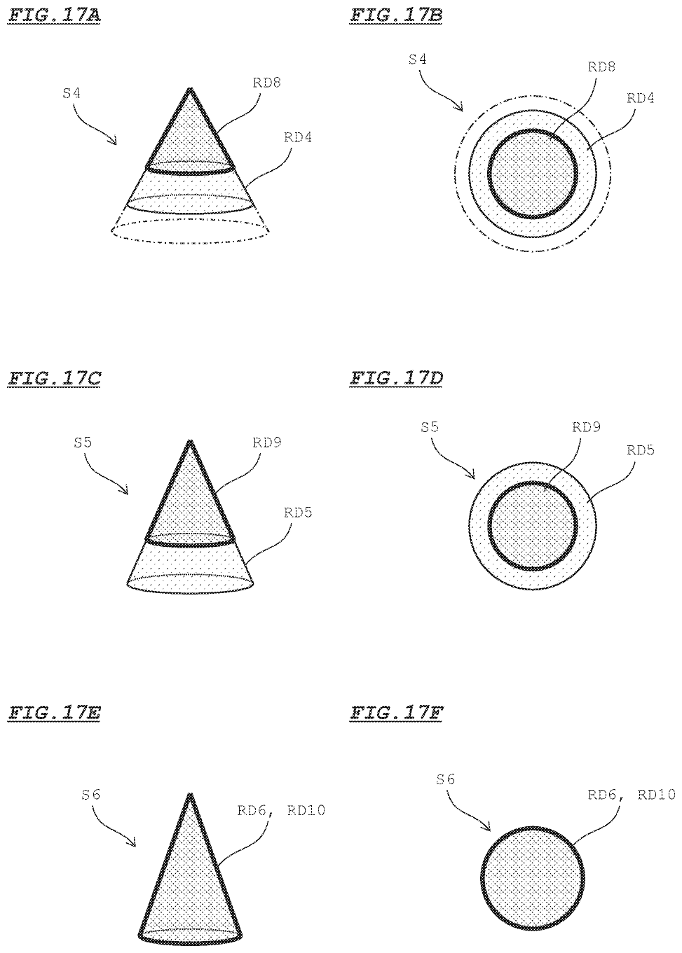

FIG. 16A to FIG. 17F schematically show the object detection surfaces and the detection ranges according to the present modification. FIGS. 16A and 16B schematically show the object detection surface S1 and the detection range RD1. FIGS. 16C and 16D schematically show the object detection surface S2 and the detection range RD2. FIGS. 16E and 16F schematically show the object detection surface S3 and the detection ranges RD3 and RD7. FIGS. 17A and 17B schematically show the object detection surface S4 and the detection ranges RD4 and RD8. FIGS. 17C and 17D schematically show the object detection surface S5 and the detection ranges RD5 and RD9. FIGS. 17E and 17F schematically show the object detection surface S6 and the detection ranges RD6 and RD10.

As shown in FIG. 16A to FIG. 17F, the controller 201 (see FIG. 8) sets the detection ranges RD1 to RD6 corresponding to the monitoring region RM1, on the object detection surfaces S1 to S6, respectively, and sets the detection ranges RD7 to RD10 corresponding to the monitoring region RM2, on the object detection surfaces S3 to S6, respectively. Similar to the above embodiment, the detection ranges RD7 to RD10 are defined by the rotational positions of the optical units 40 about the rotation axis R10 and the distance detection ranges at these rotational positions. For the monitoring region RM2 set by the user, the controller 201 calculates the detection range (rotational position, distance detection range) for each optical unit 40, and stores the calculated detection range in the internal memory in association with each optical unit 40.

Similar to the above embodiment, the controller 201 causes projection lights to be projected from the respective optical units 40 at the angles θ1 to θ6 shown in FIG. 7B, the reflected light corresponding to each projection light is received by each optical unit 40, and the controller 201 calculates the distance to an object and the angle of the position of the object. Then, the controller 201 determines whether or not the object exists in the detection ranges RD1 to RD10, on the basis of the calculated distance and angle. Accordingly, it is recognized whether or not the object is positioned in the monitoring regions RM1 and RM2 shown in FIGS. 15A and 15B.

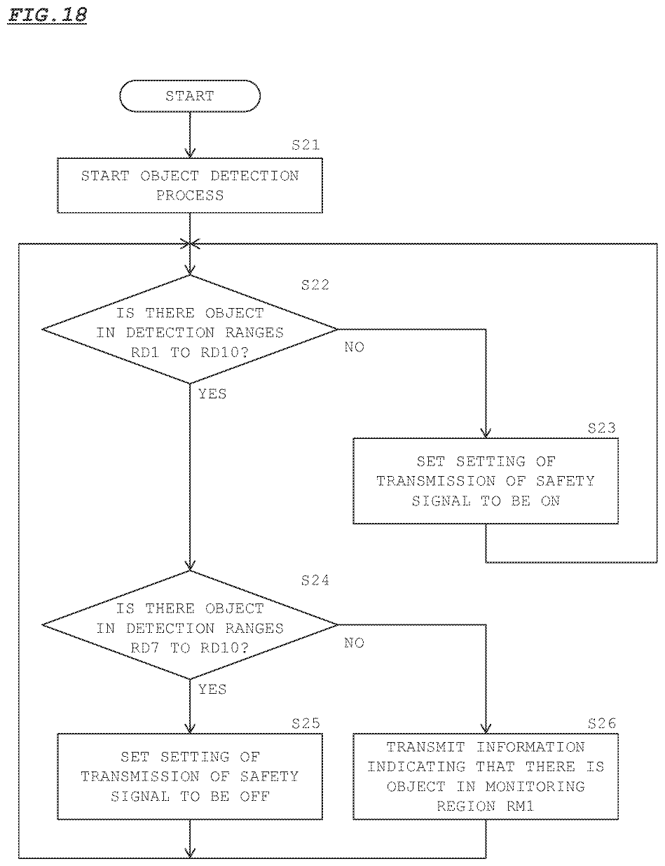

FIG. 18 is a flowchart showing an object detection process of the laser radar 1 according to the present modification.

Similar to step S11 in FIG. 13, when the controller 201 receives an instruction to start operation via the power button or the like, the controller 201 starts the object detection process (S21). By starting the object detection process, it is continuously determined at predetermined time intervals whether or not the positions of the object on the object detection surfaces S1 to S6 (distances to the object and the angles in the circumferential direction of the positions of the object) are included in the corresponding detection ranges RD1 to RD10.

When the controller 201 determines that the object is not included in any of the detection ranges RD1 to RD10 (S22: NO), the controller 201 determines that the object has not entered the monitoring regions RM1 and RM2 (safe state), and sets setting of transmission of a safety signal indicating that the monitoring regions RM1 and RM2 are in the safe state (no object is detected in the monitoring regions RM1 and RM2), to be ON (S23). Accordingly, the controller 201 transmits the safety signal to the external device 301 (see FIG. 8) via the communication part 203 (see FIG. 8). Upon receiving the safety signal from the controller 201 of the laser radar 1, the external device 301 sets the robot RB (see FIGS. 9A and 9B) to an operating state. Accordingly, when the operating speed of the robot RB is decreased, the operating speed of the robot RB is returned to a normal speed; when the robot RB is stopped, operation of the robot RB is resumed at the normal speed; and when the robot RB is operating at the normal speed, the operating state of the robot RB is continued.

On the other hand, when the controller 201 determines that the object is included in at least one of the detection ranges RD1 to RD10 (S22: YES), the controller 201 determines whether or not the object is included in the detection ranges RD7 to RD10, on the basis of the result of the object detection process used in the determination in step S22 (S24). When the controller 201 determines that the object is included in at least one of the detection ranges RD7 to RD10 (S24: YES), the controller 201 determines that the object has entered the monitoring region RM2 (unsafe state), and sets the setting of transmission of the safety signal to be OFF (S25). In this case, the safety signal is not transmitted to the external device 301. When the external device 301 no longer receives the safety signal from the controller 201 of the laser radar 1, the external device 301 stops the operation of the robot RB.

Similar to the above embodiment, also when supply of power to the laser radar 1 is stopped due to a power failure or the like, the safety signal is no longer transmitted from the laser radar 1 to the external device 301, so that the external device 301 stops the operation of the robot RB.

On the other hand, when the controller 201 determines that the object is not included in any of the detection ranges RD7 to RD10 (S24: NO), the controller 201 determines that the object has entered only the monitoring region RM1 (warning state), and transmits information indicating that the object has entered the monitoring region RM1, to the external device 301 via the communication part 203 (S26). Upon receiving the information indicating that the object has entered the monitoring region RM1 from the controller 201 of the laser radar 1, the external device 301 decreases the operating speed of the robot RB.

After executing steps S23, S25, and S26, the controller 201 returns the process to step S22, and performs the determination in step S22 again on the basis of the result of the object detection process after a predetermined time.

Instead of the flowchart of FIG. 18, the controller 201 may perform, in parallel, a process of determining whether or not an object is included in at least one of the detection ranges RD1 to RD6 and a process of determining whether or not an object is included in at least one of the detection ranges RD7 to RD10. In this case, the external device 301 may perform control in which, when the external device 301 receives a detection result that an object is included in at least one of the detection ranges RD7 to RD10 (the object has entered the monitoring region RM2), the external device 301 stops the robot RB, and when the external device 301 receives a detection result that no object is included in any of the detection ranges RD7 to RD10 (no object has entered the monitoring region RM2) and an object is included in at least one of the detection ranges RD1 to RD6 (the object has entered the monitoring region RM1), the external device 301 decreases the operating speed of the robot RB.

<Effects of Modification>

According to the above modification, the following effects are achieved.

The controller 201 (see FIG. 8) receives the setting of the two monitoring regions RM1 and RM2, sets the detection ranges RD1 to RD6 on the basis of the monitoring region RM1, and sets the detection ranges RD7 to RD10 on the basis of the monitoring region RM2. Then, the controller 201 executes the process of detecting entry of an object into the monitoring region RM1 and the process of detecting entry of an object into the monitoring region RM2. Accordingly, approach of an object to the robot RB (see FIGS. 9A and 9B) located inside the monitoring regions RM1 and RM2 can be detected stepwise for each of the two monitoring regions RM1 and RM2.

On the basis of a detection result of whether or not an object such as a person has entered the monitoring regions RM1 and RM2, the controller 201 transmits information regarding the detection result to the external device 301 via the communication part 203. Specifically, when no object has entered both of the monitoring regions RM1 and RM2, the safety signal (information regarding the detection result) is transmitted, and when an object has entered at least one of the monitoring regions RM1 and RM2, the safety signal is not transmitted. Moreover, when an object has entered only the monitoring region RM1, information indicating that the object has entered the monitoring region RM1 (information regarding the detection result) is transmitted. Accordingly, the external device 301 can perform appropriate control on the robot RB, such as stopping the robot RB or decreasing the speed of the robot RB, according to detection of entry into the monitoring region RM.

In the above modification, when an object has entered the monitoring region RM1, the operating speed of the robot RB is decreased, and when an object has entered the monitoring region RM2, the operation of the robot RB is stopped. Therefore, while high operating efficiency of the robot RB is maintained, when a person comes excessively close to the robot RB, a situation in which the arm or the like of the robot RB collides with the person can be avoided by stopping the robot RB.

The mode in which detection is performed stepwise for each of the monitoring regions RM1 and RM2 as described above is also suitable for the case where the robot RB is a cooperative robot installed at a location close to a person who performs work. If the laser radar 1 of the above modification is applied to the case where the robot RB is a cooperative robot, when a person is away from the operative robot, the cooperative robot is operated at a normal operating speed, and when the person is close to the cooperative robot, the operation of the cooperative robot is not stopped, but the operating speed of the cooperative robot is decreased, so that the operating efficiency of the cooperative robot can be maintained.

<Other Modifications>

The configuration of the laser radar 1 can be modified in various ways other than the configuration shown in the above embodiment.

For example, in the above embodiment, the motor 13 is used as a drive part that rotates the rotary part 60, but instead of the motor 13, a coil and a magnet may be disposed in the fixing part 10 and the rotary part 60, respectively, to rotate the rotary part 60 with respect to the fixing part 10. In addition, a gear may be provided on the outer peripheral surface of the rotary part 60 over the entire circumference, and a gear installed on a drive shaft of a motor installed in the fixing part 10 may be meshed with this gear, whereby the rotary part 60 may be rotated with respect to the fixing part 10.

In the above embodiment, the angles θb (see FIG. 6) of the projection directions of the projection lights projected from the respective optical units 40 are set so as to be different from each other, by installing the mirrors 42 at the inclination angles θa (see FIG. 6) different from each other, but the method for making the angles θb of the projection lights projected from the respective optical units 40 different from each other is not limited thereto.

For example, the mirror 42 may be omitted from each of the six optical units 40, and six structures 41 may be radially installed such that the inclination angles thereof with respect to the rotation axis R10 are different from each other. Alternatively, in the above embodiment, the mirror 42 may be omitted, and instead, the installation surface 21 (see FIG. 1) may be subjected to mirror finish such that the reflectance of the installation surface 21 is increased. Still alternatively, in the above embodiment, each optical unit 40 includes one mirror 42, but may include two or more mirrors. In this case, the angles θb, with respect to the rotation axis R10, of the projection lights reflected by a plurality of mirrors and projected to the scanning region may be adjusted on the basis of the angle of any of the plurality of mirrors.

In the above embodiment, the mirrors 42 are used for bending the optical axes of the projection lights emitted from the structures 41. Instead of each mirror 42, a transmission-type optical element such as a diffraction grating may be used. In this case, the laser radar 1 may be installed upside down on a ceiling or the like, and the optical axis of the projection light emitted from each structure 41 in the Z-axis negative direction may be bent in the direction away from the rotation axis R10 by the optical element.

The configuration of the optical system of each optical unit 40 is not limited to the configuration shown in the above embodiment. For example, the opening 131 may be omitted from the condensing lens 130, and the projector 81 and the light receiver 82 may be separated from each other such that the optical axis A1 of the projector 81 does not extend through the condensing lens 130. Furthermore, the number of the laser light sources 110 disposed in each optical unit 40 is not limited to one, and may be a plural number. In this case, laser lights emitted from the respective laser light sources 110 may be integrated by a polarizing beam splitter or the like, thereby generating projection light.

In the above embodiment, the six sets of the projectors 81 and the light receivers 82 (see FIG. 5) are installed along the circumferential direction about the rotation axis R10, but the number of sets of the projectors 81 and the light receivers 82 installed is not limited to six, and may be 2 to 5, or may be 7 or more. In this case as well, the inclination angles θa of the mirrors 42 included in the projectors 81 and the light receivers 82 are set so as to be different from each other, and the angles θb of the projection lights reflected by the respective mirrors 42 are set to acute angles different from each other.

In the above embodiment, the six projectors 81 are arranged along the circumference centered on the rotation axis R10, but may be arranged in the radial direction centered on the rotation axis R10. Alternatively, the six projectors 81 may be arranged so as to be spaced apart from each other in the circumferential direction centered on the rotation axis R10 and be displaced relative to each other in the direction away from the rotation axis R10.

In the above embodiment, each projector 81 includes one laser light source 110, but may include two or more laser light sources. In the above embodiment, each light receiver 82 include one photodetector 150, but may include two or more photodetectors. In addition, each photodetector 150 may include two or more sensors, and reflected light may be received by the two or more sensors.

In the above embodiment, when the controller 201 determines that an object is included in at least one of the detection ranges RD1 to RD6 (S12 in FIG. 13: YES), the controller 201 may transmit information indicating that the object has entered the monitoring region RM (information regarding the detection result), to the external device 301 via the communication part 203. In addition, in the above modification, when the controller 201 determines that an object is included in at least one of the detection ranges RD7 to RD10 (S24 in FIG. 18: YES), the controller 201 may transmit information indicating that the object has entered the monitoring region RM2 (information regarding the detection result), to the external device 301 via the communication part 203. It should be noted that if the transmission of the safety signal is stopped when entry of an object is detected as in the above embodiment and modification, the external device 301 can stop the robot RB even when the supply of power to the laser radar 1 is stopped due to a power failure or the like.

In the above modification, the two monitoring regions RM1 and RM2 are set, and for each of the two monitoring regions RM1 and RM2, the process of detecting entry of an object into the monitoring region is executed. However, the number of monitoring regions is not limited to two, and may be three or more. In this case, for each of the three or more monitoring regions, the controller 201 executes a process of detecting entry of an object into the monitoring region.

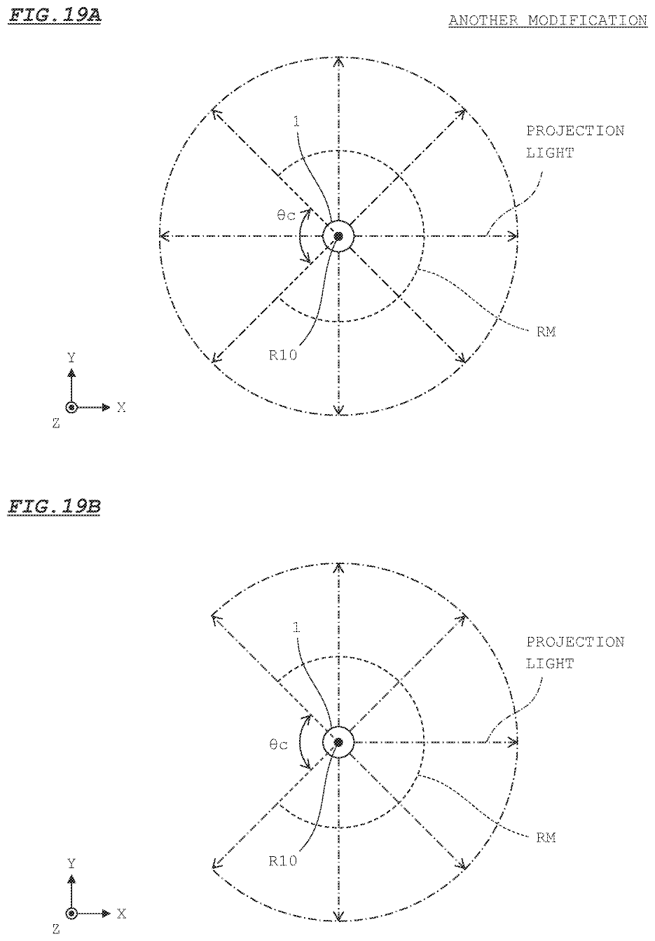

In the above embodiment, the cylindrical monitoring region RM is set over the entire circumference of 360° around the rotation axis R10, but the monitoring region RM may be set at a part of the circumference around the rotation axis R10 as shown in FIGS. 19A and 19B.

FIGS. 19A and 19B are each a plan view schematically showing a monitoring region RM and projection light according to another modification, as viewed in the Z-axis negative direction. In the case of FIG. 19A, the monitoring region RM is not set in a range of an angle θc centered on the rotation axis R10, and thus the controller 201 does not set the detection ranges RD1 to RD6 in the range of the angle θc. In the case where the monitoring region RM is at a part of the circumference around the rotation axis R10 as in FIG. 19A, as shown in FIG. 19B, the laser radar 1 does not have to project projection light to the range of the angle θc. In the case where a wall or the like exists in the range of the angle θc, for example, the monitoring region RM is set at a part of the circumference around the rotation axis R10 as in FIGS. 19A and 19B.

In the above embodiment, the laser radar 1 is installed on the ceiling or the like above the robot RB installed on the ground, but the laser radar 1 may be installed on the ground or the like below the robot RB installed on a ceiling. In this case, the upper surface of the fixing part 10 of the laser radar 1 is set on the ground, and projection light is projected from the laser radar 1 toward the robot RB located above the laser radar 1, that is, toward the ceiling.

In the above embodiment, the laser radar 1 is connected to the external device 301 and the external terminal 302 via the communication part 203. However, the laser radar 1 may have the configurations of the external device 301 and the external terminal 302.

In addition to the above, various modifications can be made as appropriate to the embodiments of the present invention, without departing from the scope of the technological idea defined by the claims.

What is claimed is:

1. A laser radar comprising:
a projector configured to project laser light emitted from a light source, in a direction having an acute angle with respect to a rotation axis;
a light receiver configured to condense reflected light, of the laser light, by an object, onto a photodetector;
a rotary part configured to rotate the projector and the light receiver about the rotation axis to form an object detection surface having a conical shape; and
a controller configured to detect entry of the object into a three-dimensional monitoring region, wherein
the object detection surface is set so as to widen toward the monitoring region, and
the controller sets a detection range corresponding to the monitoring region, on the object detection surface, and detects entry of the object into the monitoring region by a position of the object on the object detection surface, which is detected on the basis of emission of the laser light and reception of the reflected light, being included in the detection range.

2. The laser radar according to claim 1, wherein
a plurality of sets of the projectors and the light receivers are disposed, and
angles of projection directions of the laser lights of the respective sets with respect to the rotation axis are different from each other.

3. The laser radar according to claim 2, wherein the controller sets a detection range corresponding to the monitoring region, on the object detection surface formed by each of the sets, and executes a process of detecting entry of the object into the monitoring region, for each of the sets.

4. The laser radar according to claim 2, wherein
the projector of each of the sets includes a mirror configured to reflect the laser light, and
an inclination angle of the mirror is made different for each of the sets to make the angle of the projection direction of the laser light with respect to the rotation axis to be different for each of the sets.

5. The laser radar according to claim 2, wherein the plurality of the projectors are arranged along a circumference centered on the rotation axis.

6. The laser radar according to claim 1, wherein the controller receives setting of the monitoring region, and sets the detection range corresponding to the received monitoring region, on the object detection surface.

7. The laser radar according to claim 6, wherein the controller receives setting of a plurality of the monitoring regions, sets the detection range for each of the monitoring regions, and executes a process of detecting entry of the object into the plurality of the monitoring regions.

8. The laser radar according to claim 1, further comprising a communication part configured to communicate with an external device configured to control equipment disposed inside the monitoring region, wherein
on the basis of a detection result of whether or not the object has entered the monitoring region, the controller transmits information regarding the detection result, to the external device via the communication part.

9. The laser radar according to claim 1, wherein the angle of the projection direction of the laser light with respect to the rotation axis is set so as to be not less than 10° and not greater than 60°.
